(19) United States
(12) Patent Application Publication
(10) Pub. No.: US 2016/0063425 A1
(43) Pub. Date: Mar. 3, 2016

(54) APPARATUS FOR PREDICTING FUTURE VENDOR PERFORMANCE

(71) Applicant: BOTTOMLINE TECHNOLOGIES (DE) INC., Portsmouth, NH (US)

(72) Inventors: Karen Fettig, Stratham, NH (US); Aaron Landry, Alpharetta, GA (US)

(21) Appl. No.: 14/475,765

(22) Filed: Sep. 3, 2014

(51) Int. Cl. G06Q 10/06; G06Q 50/18

(52) U.S. Cl. CPC G06Q 10/06393; G06Q 50/18

(57) ABSTRACT

The present disclosure provides a vendor procurement apparatus for predicting future vendor performance for a new task based on previous vendor performance. The future vendor performance is determined by comparing the vendor's performance in related previously performed tasks to industry benchmarks in order to determine a rating for the previously performed tasks. These ratings are then weighted according to carrier specifications and averaged to create a prediction of vendor performance.

### TECHNICAL FIELD

The present invention relates to the procurement of vendor services, more particularly, to a method and system for predicting future performance of a provider of legal professional services based on previous performance of the provider.

### BACKGROUND OF THE INVENTION

Carriers frequently need to employ vendors in areas across the country that are outside the carrier's normal area of operation. For example, insurance carriers often need to hire court reporters, adjusters, and attorneys across the United States to defend the insurance carriers in slip and fall cases, medical malpractice cases, car accident cases, worker's compensation cases, etc.

### SUMMARY OF THE INVENTION

The selection of vendors by carriers can be a difficult task. For example, if an insurance carrier needs to hire a medical malpractice attorney to represent it in a court in a faraway state, it can require large amounts of time and money to locate attorneys that specialize in medical malpractice, are located near the court, and are admitted to practice law in the faraway state. It can take even more time (1) to gather data regarding the attorneys in order to determine which attorneys meet specified criteria and (2) to evaluate which attorney to hire. For example, an insurance carrier may wish to select the attorney that is the most effective and that has an average total cost less than a given amount. There is no guarantee that the subjective judgment performed by the insurance carrier will result in selecting the attorney best suited to the insurance carriers' needs. This inefficient, ad hoc, and subjective decision making processes for vendor procurement and management in, e.g., the insurance industry causes higher costs for policyholders.

A vendor selection tool is needed that allows carriers to efficiently select a vendor based on predefined criteria. The selection tool should also allow the carrier to differentiate between vendors by weighting different metrics applied to the vendors. Such a vendor selection tool provides real world value by decreasing the time and money spent in the process of identifying and selecting vendor partners.

The present disclosure provides a vendor procurement apparatus for predicting future vendor performance for a new task based on previous vendor performance. The prediction of future performance is determined as a measure of a vendor's comparative performance to other vendors on similar tasks using weighted historical data.

According to one aspect of the disclosure, there is provided a vendor procurement apparatus for predicting future vendor performance for a new task based on previous vendor performance. The vendor procurement apparatus includes a non-transitory computer readable medium storing a vendor database. The vendor database stores a list of vendor entries regarding a group of vendors and at least one property for each vendor of the group of vendors. Each vendor entry identifies a particular vendor and objective data for at least one previous task performed by the particular vendor. The objective data includes metrics regarding the particular vendor's performance of the associated previous task. The vendor procurement apparatus also includes a network interface configured to receive from a carrier a search request pertaining to the new task and properties of a desired vendor. The vendor procurement apparatus further includes a processor configured to identify at least one vendor in the vendor database. Each identified vendor has at least one property that matches at least one property of the desired vendor. For each identified vendor, the processor is configured to identify at least one matching previous task performed by the identified vendor that matches at least one characteristic of the new task, determine other matching tasks in the vendor database that match at least one characteristic of the matching previous task performed by the identified vendor, and determine statistical properties of the metrics associated with the other matching tasks. For each identified at least one matching previous task performed by the identified vendor, the processor is configured to, for each metric associated with the identified matching previous task, convert the metric into a metric rating based on the determined statistical properties of that metric for the other matching tasks and determine a task rating for the identified matching previous task based on the at least one metric rating and a weighting factor. The weighting factor applies a weight to each metric rating. The processor also determines a prediction of future performance of the new task by the identified vendor based on the determined at least one task rating.

Alternatively or additionally, the prediction of future performance for a given vendor is an average of the determined at least one task rating.

Alternatively or additionally, the determined statistical properties of the metrics associated with the other matching tasks include the mean value and the standard deviation of the metrics. The metric rating for a given metric associated with the identified matching task is equal to a constant value plus or minus a number of half standard deviations by which the given metric differs from the mean value of that metric associated with the other matching tasks.

Alternatively or additionally, the metric rating is determined for each metric associated with the identified matching previous task and the task rating is equal to the sum of each metric rating multiplied by the weight associated with the metric divided by the sum of the weights associated with each metric rating.

Alternatively or additionally, the constant value equals 5.

Alternatively or additionally, the weighting factor is received as part of the search request and/or is stored in a weighting factor database stored in the non-transitory computer readable medium.

Alternatively or additionally, the carrier specifies the criteria for determining whether a particular property of a particular vendor matches a particular property of the desired vendor and/or whether a particular previous task stored in the vendor database matches the at least one characteristic of the new task.

Alternatively or additionally, the criteria for determining whether a particular property of a particular vendor matches a particular property of the desired vendor and/or whether a particular previous task stored in the vendor database matches the at least one characteristic of the new task is stored in a criteria matching database stored in the non-transitory computer readable medium.

Alternatively or additionally, the other matching tasks do not include previous tasks performed by the identified vendor.

Alternatively or additionally, the new task is requested by an insurance carrier and the vendors provide professional services.

Alternatively or additionally, the processor is further configured to analyze the new task to determine the at least one characteristic of the new task. The network interface is further configured to receive at least one characteristic of the new task.

Alternatively or additionally, the network interface is further configured to provide to the carrier information regarding the determined prediction of future performance of the identified at least one vendor.

Alternatively or additionally, the identified at least one vendor includes multiple vendors. The information regarding the determined prediction of future performance of the identified vendors is rank ordered based on the prediction of future performance associated with each vendor of the identified vendors.

According to another aspect of the disclosure, there is provided a method for predicting future vendor performance for a new task based on previous vendor performance. The method includes receiving from a carrier a search request pertaining to the new task and properties of a desired vendor and identifying at least one vendor in a vendor database stored on a non-transitory computer readable medium. Each identified vendor has at least one property that matches at least one property of the desired vendor. For each identified vendor, the method identifyies at least one matching previous task performed by the identified vendor that matches at least one characteristic of the new task, determines other matching tasks stored in the vendor database that match at least one characteristic of the matching previous task performed by the identified vendor, and determines statistical properties of metrics associated with the other matching tasks. For each identified at least one matching previous task performed by the identified vendor and for each metric associated with the identified matching previous task, the method converts the metric into a metric rating based on the determined statistical properties of that metric for the other matching tasks. For each identified at least one matching previous task, the method also determines a task rating for the identified matching previous task based on the at least one metric rating and a weighting factor. The weighting factor applies a weight to each metric rating. The method also determines a prediction of future performance of the new task by the identified vendor based on the determined at least one task rating.

Alternatively or additionally, the prediction of future performance for a given vendor is an average of the determined at least one task rating.

Alternatively or additionally, the determined statistical properties of the metrics associated with the other matching tasks include the mean value and the standard deviation of the metrics. The metric rating for a given metric associated with the identified matching task is equal to a constant value plus or minus a number of half standard deviations by which the given metric differs from the mean value of that metric associated with the other matching tasks.

Alternatively or additionally, the metric rating is determined for each metric associated with the identified matching previous task. The task rating is equal to the sum of each metric rating multiplied by the weight associated with the metric divided by the sum of the weights associated with each metric rating.

According to an additional aspect of the disclosure, there is provided a legal professional service procurement apparatus for predicting future performance of a provider of professional services to insurance carriers for a new task based on previous performance. The procurement apparatus includes a non-transitory computer readable medium storing a professional service provider database. The professional service provider database stores a list of provider entries regarding a group of providers of professional services to insurance carriers and at least one property for each provider of the group of providers. Each provider entry identifies a particular provider and objective data for at least one previous task performed by the particular provider. The objective data includes metrics regarding the particular provider's performance of the associated previous task. The procurement apparatus also includes a network interface configured to receive from an insurance carrier a search request pertaining to the new task and properties of a desired provider. The procurement apparatus further includes a processor configured to identify at least one provider in the professional service provider database, wherein each identified provider has at least one property that matches at least one property of the desired provider. For each identified provider, the procurement apparatus identifies at least one matching previous task performed by the identified provider that matches at least one characteristic of the new task, determines other matching tasks in the professional service provider database that match at least one characteristic of the matching previous task performed by the identified vendor, and determines statistical properties of the metrics associated with the other matching tasks. For each identified at least one matching previous task performed by the identified vendor, the procurement apparatus is configured to, for each metric associated with the identified matching previous task, convert the metric into a metric rating based on the determined statistical properties of that metric for the other matching tasks and determine a task rating for the identified matching previous task based on the at least one metric rating and a weighting factor. The weighting factor applies a weight to each metric rating. The procurement apparatus is also configured to determine a prediction of future performance of the new task by the identified provider based on the determined at least one task rating.

Alternatively or additionally, the prediction of future performance for a given provider is an average of the determined at least one task rating.

Alternatively or additionally, the determined statistical properties of the metrics associated with the other matching tasks include the mean value and the standard deviation of the metrics. The metric rating for a given metric associated with the identified matching task is equal to a constant value plus or minus a number of half standard deviations by which the given metric differs from the mean value of that metric associated with the other matching tasks.

Alternatively or additionally, the metric rating is determined for each metric associated with the identified matching previous task. The task rating is equal to the sum of each metric rating multiplied by the weight associated with the metric divided by the sum of the weights associated with each metric rating.

A number of features are described herein with respect to embodiments of this disclosure. Features described with respect to a given embodiment also may be employed in connection with other embodiments.

For a better understanding of the present disclosure, together with other and further aspects thereof, reference is made to the following description, taken in conjunction with the accompanying drawings. The scope of the disclosure is set forth in the appended claims, which set forth in detail certain illustrative embodiments. These embodiments are indicative, however, of but a few of the various ways in which the principles of the disclosure may be employed.

### BRIEF DESCRIPTION OF THE DRAWINGS

FIG. 1 is a block diagram representing the connections formed between a vendor procurement apparatus, carrier system, and vendor system.

FIG. 2 is a block diagram of a vendor procurement system.

FIG. 3 is a block diagram of a search request.

FIG. 4 is a block diagram of a vendor database.

FIG. 5 is a ladder diagram representing transmission of information between the vendor procurement apparatus, carrier system, and vendor system.

FIG. 6 is an exemplary user interface for a carrier to enter desired vendor properties.

FIG. 7 is an exemplary user interface for modifying the weight applied to a metric associated with previously performed tasks.

FIG. 8 is an exemplary user interface for displaying a list of identified vendors.

FIG. 9 is an exemplary vendor profile page for a vendor selected from the list of identified vendors in FIG. 8.

FIG. 10 is a flow diagram representing a method for predicting future vendor performance for a new task based on previous vendor performance.

### DETAILED DESCRIPTION OF THE INVENTION

The present invention is now described in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

It should be appreciated that many of the elements discussed in this specification may be implemented in a hardware circuit(s), a processor executing software code or instructions which are encoded within computer readable media accessible to the processor, or a combination of a hardware circuit(s) and a processor or control block of an integrated circuit executing machine readable code encoded within a computer readable media. As such, the term circuit, module, server, application, or other equivalent description of an element as used throughout this specification is, unless otherwise indicated, intended to encompass a hardware circuit (whether discrete elements or an integrated circuit block), a processor or control block executing code encoded in a computer readable media, or a combination of a hardware circuit(s) and a processor and/or control block executing such code.

The present disclosure provides a vendor procurement apparatus for predicting future vendor performance for a new task based on previous vendor performance. The future vendor performance is determined by comparing the vendor's performance in related previously performed tasks to industry benchmarks in order to determine a rating for the previously performed tasks. These ratings are then weighted according to carrier specifications and used to determine a prediction of vendor performance.

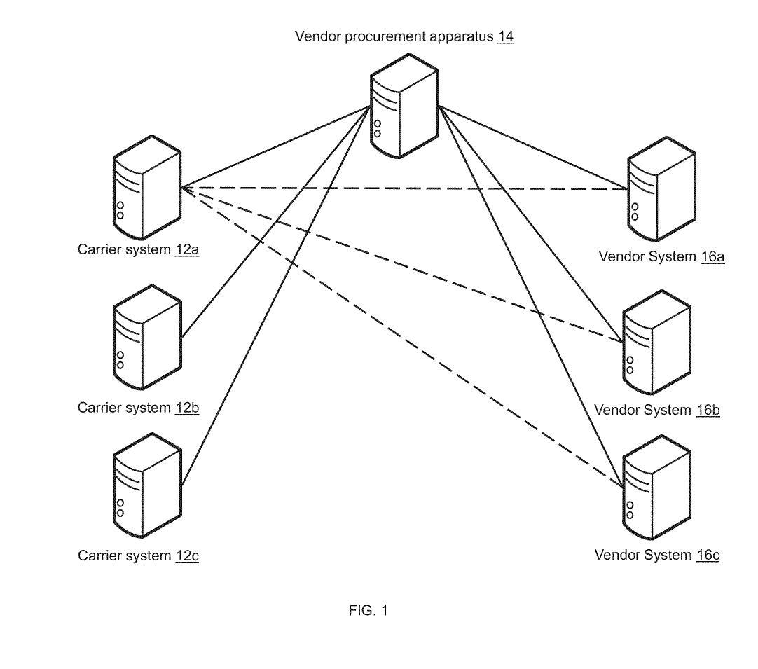

FIG. 1 depicts communication between carrier systems 12a-c, a vendor procurement apparatus 14, and vendor systems 16a-c. When a carrier system 12 requires the services of a vendor regarding a new task, the carrier system 12 sends a search request to the vendor procurement apparatus 14 that pertains to the new task and includes properties of a desired vendor. Upon receiving the properties of the desired vendor, the vendor procurement apparatus 14 identifies vendors having properties matching properties of the desired vendor. For each identified vendor, the vendor procurement apparatus 14 then determines a prediction of future performance of the new task by the vendor. This prediction of future performance is then transmitted by the vendor procurement apparatus 14 to the carrier system 12. The carrier system 12 then selects a vendor system 16 to perform the new task. The selected vendor may be sent to the vendor procurement apparatus 14 and the vendor procurement apparatus 14 may put the carrier system 12 in communication with the selected vendor 16.

Communication between the vendor procurement apparatus 14 and the carrier systems 12 and vendor systems 16 is shown with solid lines. Communication between the carriers 12 and the vendors 16 is shown using dashed lines. FIG. 1 only shows communication between a single carrier system 12a and the vendor systems 16a-c in order to reduce clutter in the figure and to make it easier to view the communication between the vendor procurement apparatus 14, the carriers 12, and the vendors 16.

Upon completion of the new task by the selected vendor 16, the selected vendor 16 and/or the carrier system 12 report metrics regarding the performance of the new task to the vendor procurement apparatus 14. For example, metrics may include the hours billed by the selected vendor, the outcome of the new task, the total cost of the new task, etc. This information is then stored by the vendor procurement apparatus 14.

In one embodiment, the carrier systems 12 are insurance carriers. In this embodiment, the vendors include providers of professional services to insurance carriers, e.g., court reporters, attorneys, independent adjusters, independent medical examiners, experts (accident reconstruction, medical, engineer, etc.), etc.

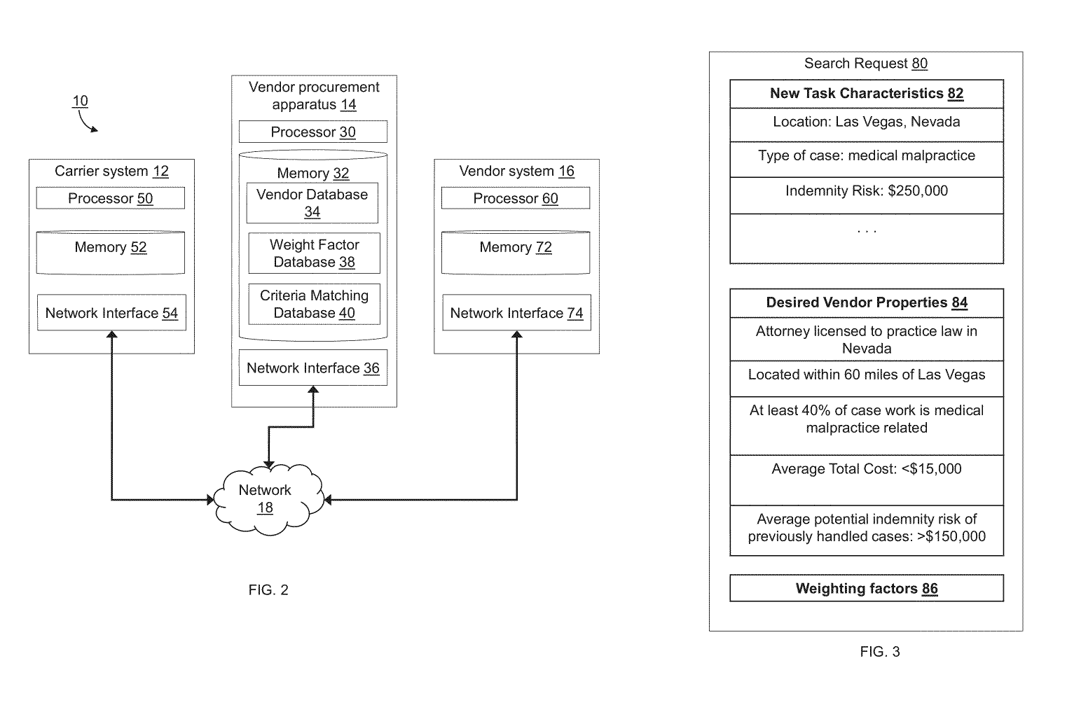

Turning to FIG. 2, a vendor procurement system 10 is shown. The system 10 includes at least one carrier system 12 (also referred to as a “carrier”), a vendor procurement apparatus 14, and at least one vendor system 16 (also referred to as a “vendor”). The financial messaging apparatus 14 receives a search request pertaining to a new task and properties of a desired vendor from carrier systems 12 via a network interface 36. For example, the financial messaging apparatus 14 may receive from the carrier system 12 (1) a search request for a medical malpractice case in Las Vegas, Nev. and (2) properties of a desired vendor specifying an attorney within 60 miles of Las Vegas, licensed to practice in Nevada, and having performed more than 50% of his/her work on medical malpractice cases. As will be described in greater detail below, in order to identify vendors matching the properties of the desired vendor, a processor 30 of the vendor procurement apparatus 14 analyzes vendor entries in a vendor database 34 stored in a non-transitory computer readable medium 32 of the vendor procurement apparatus 14. After identifying vendors matching the properties of the desired vendor, the processor 30 determines a prediction of future performance of the new task by each identified vendor. The processor 30 determines the prediction of future performance by comparing the performance of the identified vendor in tasks similar to the new task (i.e., the task the search request is related to) with the performance of other vendors in similar tasks. The prediction of future performance of the new task by the identified vendors is then transmitted by the network interface 36 of the vendor procurement apparatus 14 to the carrier system 18 via the network 18.

The carrier system 12, vendor procurement apparatus 14, and vendor system 16 may be a computer system of one or more servers that each include at least a processor 30, 50, 60, a network interface 36, 54, 74, and non-transitory computer readable medium 32, 52, 72. The computer readable medium may include encoded thereon instructions for interfacing with the corresponding network interface and reading and writing data to the corresponding computer readable medium. The computer readable medium may also include computer programs comprising instructions embodied thereon that are executed by the corresponding processor.

Turning to FIG. 3, an exemplary search request 80 is shown. The exemplary search request 80 includes the new task characteristics 82 and/or the properties of the desired vendor 84. For example, the search report 80 may comprise a single data structure or separate but linked data structures. For example, the new task characteristics 82 and desired vendor properties 84 may be included in a container that ensures the new task characteristics 82 and desired vendor properties 84 are transmitted together by the carrier system 12. Alternatively, the desired vendor properties 84 may be received as a separate file from the search request 80.

In another example, the search request 80 may contain only the desired vendor properties 84. That is, the processor may analyze the new task to determine the characteristic(s) of the new task. In this example, the new task characteristics 82 may be determined based on the properties of the desired vendor 84. For example, in FIG. 3 the desired vendor properties 84 specify that the carrier desires to locate an attorney (1) licensed to practice in Nevada, (2) located within 60 miles of Las Vegas, (3) with at least 40% of his/her case work related to medical malpractice, (4) averages a total cost of less than $15,000, and (5) the average potential indemnity of cases handled by the attorney is greater than $150,000. In this example, the new task characteristics 82 may be determined by the processor 30 of the vendor procurement apparatus 14 to be a (1) medical malpractice case (2) located in Las Vegas, Nev. and (3) having an indemnity risk of at least $150,000.

As is described in further detail below, the search request 80 may additionally include a weighting factor 86.

As will be understood by one of ordinary skill in the art, the search request 80 may be sent in any suitable format. For example, the format of the search request 80 may be a plain text document, spreadsheet, or proprietary format.

The search report 80 is not limited to information regarding a single new task, but may contain information regarding multiple new tasks. For example, a separate new task characteristic 82 and desired vendor property 84 may be contained in the search request 80 for each new task. In one example, the new tasks (for which information is contained in the search request 80) may all be related. For example, continuing the exemplary Las Vegas, Nev. medical malpractice case, the carrier system 12 may send a single search request 80 requesting that the vendor procurement apparatus 14 identify court reporters, attorneys, and expert witnesses for use in the example case.

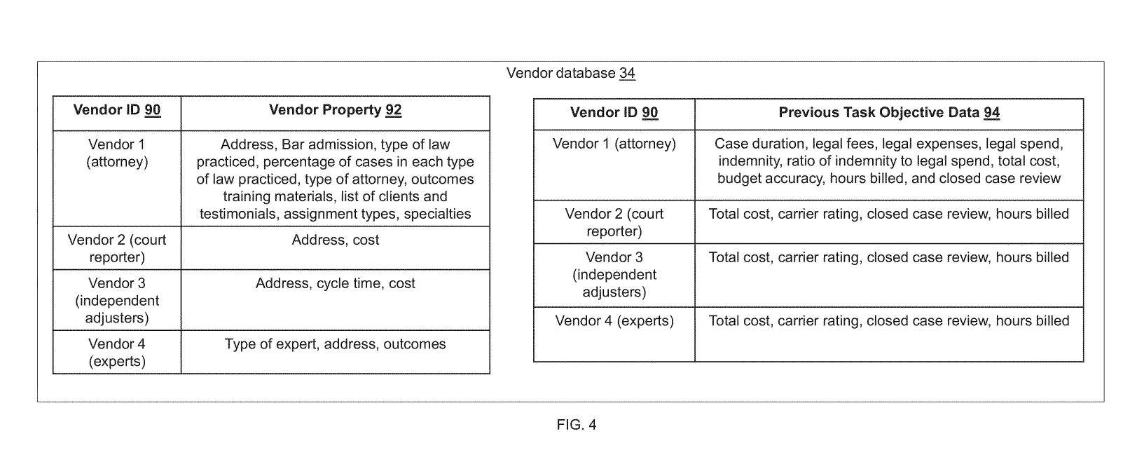

After the network interface 36 receives the search request 80 and properties of the desired vendor 84, the processor 30 searches for vendors matching the desired vendor properties 84 using a vendor database 34 stored on the non-transitory computer readable medium 32. The vendor database stores a list of vendor entries regarding a group of vendors and at least one property for each vendor of the group of vendors. As shown in FIG. 4, each vendor entry identifies a particular vendor 90, properties of the vendor 92, and objective data 94 for at least one previous task performed by the particular vendor. The objective data 94 includes metrics regarding the particular vendor's performance of the associated previous task.

The vendor properties may depend on the type of services rendered by the vendor. For example, the vendor properties 92 of a vendor that is an attorney may include location (i.e., address), states admitted to practice law, type of law practiced, percentage of cases in each type of law practiced, type of attorney (e.g., individual or firm), outcomes (e.g., amount of indemnity paid, awards or dismissals for mediation and trials, etc.), wins (e.g., dismissal in a jury trial/arbitration), outcomes of trials in which the attorney was first chair, training materials provided by the attorney for the carriers (e.g., case studies), list of clients and testimonials, assignment types (e.g., Examination under oath, coverage opinions, defending a case), and specialties (e.g., fraud, slip and fall, worker's compensation, etc.). In another example, the vendor properties 92 of a vendor that is an independent adjuster may include address, cycle time (i.e., how long to close case once received), and cost.

The metrics stored in the vendor database 34 may also differ depending on the vendor type. For example, the previous task objective data 94 for an attorney may include metrics regarding case duration, legal fees, legal expenses, legal spend (sum of legal fees and legal expenses), indemnity, ratio of indemnity to legal spend, total cost (legal spend plus indemnity), budget accuracy, hours billed, and closed case review. Closed case review may be ratings supplied by the carrier that hired the vendor to perform the previous task. The closed case review may include ratings evaluating ethics, strategy (e.g., was the strategy consistent throughout the case, was the strategy effective, etc.), communication (e.g., was communication prompt, did the vendor follow communication guidelines specified by the carrier, etc.), and efficiency of staffing. In another example, the previous task objective data 94 for a court reporter, independent adjuster, and/or expert may be limited to total cost, carrier rating, closed case review, and hours billed.

As described above, the metrics stored in the vendor database 34 may vary depending on the type of vendor. The vendor entry for a given vendor may also not include each metric stored for other vendors of the same type as the given vendor. For example, the vendor entry for attorney A may include four metrics, while the vendor entry for attorney B may include 6 metrics.

As will be understood by one of ordinary skill in the art, the metrics stored in the vendor database 34 are not limited to those described above. The metrics may be adjusted to reflect any data useful to a carrier 12 or the vendor procurement apparatus 14 in order to select or predict the performance of a vendor.

The processor 30 of the vendor procurement apparatus 14 identifies at least one vendor in the vendor database 34 that has at least one property that matches at least one property of the desired vendor. In one example, the processor 30 may identify multiple vendors that match each of the properties of the desired vendor 84. In this example, the processor 30 does not identify any vendors that do not match all of the properties of the desired vendor 84. That is, the processor 30 limits the identification of vendors to vendors that match all of the properties of the desired vendor, because multiple vendors were identified without needing to lower the matching requirements to identify vendors. In another example, however, the processor 30 may also identify vendors that match a majority of the properties of the desired vendor 84 (e.g., 75% or more). The number of properties of the desired vendor 84 that a particular vendor must match to be identified may be determined based on the total number of identified vendors. For example, if only ten vendors match all of the desired vendor properties, the processor 30 may also identify all the vendors that match all but one of the desired vendor properties. If there are twenty additional vendors that match all but one of the desired vendor properties, then the processor 30 may stop identifying additional vendors. If, however, there are only ten additional vendors that match all but one of the desired vendor properties, then the processor 30 may also identify all of the vendors that match all but two of the desired vendor properties. In this way, the processor 30 may ensure that a given number of vendors are identified by decreasing the number of desired vendor properties 84 that a vendor must meet to be identified by the processor 30.

The carrier 12 may specify the criteria for determining whether a property of a vendor matches a particular property of the desired vendor. For example, a desired vendor property 84 may be that the vendor specializes in worker's comp cases. In this example, the carrier 12 may provide with the search request 80 the criteria for determining whether a vendor specializes in worker's comp cases. The carrier 12 may, e.g., specify that an attorney that spends at least 40% of his/her time litigating worker's comp cases qualifies as a specialist in worker's comp cases.

In another example, the criteria for determining whether a property of a given vendor matches a particular property of the desired vendor may be stored in a criteria matching database 40 stored in the non-transitory computer readable medium 32 of the vendor procurement apparatus 14. In this example, the carrier 12 may have previously supplied the criteria stored in the criteria matching database 40. Alternatively, the criteria stored in the criteria matching database 40 may be based on a default criteria set by the vendor procurement apparatus 14 or a mixture of the default criteria and criteria supplier by the carrier 12. The default criteria may be the default setting for each search request 80 supplied by a carrier 12 unless the carrier 12 supplies an alternative criteria.

After the processor 30 identifies the vendor(s) matching the properties of the desired vendor, the processor 30 identifies at least one matching previous task performed by each identified vendor. A matching previous task is (1) a task previously performed by a given identified vendor and (2) a task that matches at least one characteristic of the new task. For example, if vendor A is identified, then the processor 30 may identify all tasks previously performed by vendor A that match all of the characteristics of the new task 82. In another example, the processor 30 may identify the most recent tasks previously performed by vendor A that match all of the characteristics of the new task 82. In still another example, the processor 30 may identify those tasks previously performed by vendor A that match at least a majority (e.g., 50%, 75%, 85%, 95%, etc.) of the characteristics of the new task 82.

The processor 30 also determines other matching tasks in the vendor database 34 that match characteristic(s) of the matching previous task performed by the identified vendor. For example, if the processor 30 locates a task performed by vendor A in 2010 that matches the characteristics of the new task, the processor 30 will also locate other tasks that match the characteristics of the 2010 task performed by vendor A. These other tasks that match the characteristics of the 2010 task are then used to evaluate vendor A's performance in the 2010 task. In another embodiment, the processor 30 may instead determine other matching tasks in the vendor database 34 that match the characteristic(s) of the new task. In both examples, the other matching tasks may be limited to those previous tasks not performed by the identified vendor.

By comparing the matching previous task performed by the identified vendor to other tasks similar to the matching previous task, a task rating may be determined and stored for each previously performed task without waiting for a search request regarding a new task. In this way, upon receiving a search request, the vendor procurement apparatus 14 may locate matching previous tasks performed by the identified vendor and use the already determined task ratings for the matching previous tasks to determine a prediction of future performance of the new task by an identified vendor.

The carrier 12 may specify the criteria for determining whether a particular previous task stored in the vendor database 34 matches the characteristic(s) of the new task. In another example, the criteria for determining whether a particular previous task stored in the vendor database 34 matches the characteristic(s) of the new task is stored in a criteria matching database 40 stored in the non-transitory computer readable medium 32. The criteria may comprise a range of acceptable values for different possible characteristics of the new task. For example, assume a characteristic of the new task is a potential indemnity of $150,000. The criteria may specify that previous tasks match the characteristic of potential indemnity of the new task, if the potential indemnity of the previous task fell within the range of the potential indemnity of the new task ±20%. Therefore, in this example, any previous task would match this characteristic if the potential indemnity was within the range of $120,000 to $180,000. As will be understood by one of ordinary skill in the art, the criteria may specify, e.g., any suitable range of values or a specific value for each characteristic of the new task.

Characteristics of the new task may include venue, potential indemnity, type of task (e.g., medical malpractice case, worker's comp case, etc.), budget, etc. As will be understood by one of ordinary skill in the art, characteristics of the new task are not limited to these examples, but may include any characteristic that can be used to compare a new task to previously performed tasks to determine if the two tasks are similar.

The processor 30 determines statistical properties of the metrics associated with the other matching tasks. The determined statistical properties of the metrics associated with the other matching tasks may include the mean value and the standard deviation of the metrics. The determined statistical properties may also include other statistical properties of the metrics. As described in further detail below, the determined statistical properties are used to rate the identified vendor's previously performed tasks.

The processor 30 converts each metric associated with the identified matching previous task performed by the identified vendor into a metric rating based on the determined statistical properties of the other matching tasks. The metric rating for a given metric associated with the identified matching task may be equal to a constant value plus or minus a number of half standard deviations by which the given metric differs from the mean value of that metric associated with the other matching tasks. The metric rating may be determined for each metric associated with the identified matching previous task.

For example, Bob the attorney is identified as a vendor matching the characteristics of the desired vendor for a worker's compensation case in Reno, Nev. A worker's compensation assignment previously performed by Bob is stored in the vendor database along with multiple metrics. Bob's rating for the completed assignment may be assessed by converting each metric for the completed assignment into a metric rating. If Bob's cycle time (i.e., one of the metrics) for the completed assignment is d₁, then d₁ is transformed into a metric rating r₁ by comparing d₁ to similar tasks. For example, as described above, d₁ may be compared to other tasks identified in the vendor database that are similar to (i.e., match the characteristic(s) of) the worker's compensation assignment being evaluated. In this example, r₁ is defined as variation from the mean of the other similar tasks. In one embodiment, r₁ is equal to a constant value (e.g., 5) ±the number of half standard deviations by which d₁ differs from the mean of the cycle time (i.e., the metric) for the other similar tasks.

A task rating is determined for the identified matching previous task based on the metric rating(s) determined for the identified matching previous task and a weighting factor. The weighting factor applies a weight to each metric rating. In one example, the task rating may be equal to the sum of each metric rating for the identified matching previous task multiplied by the weight associated with the metric divided by the sum of the weights associated with each metric rating. That is, where r₁, r₂, . . . , rₓ are metric ratings for a given previous task and w₁, w₂, . . . , wₓ are weighting factors for the respective metric ratings, the task rating R is determined using the following equation:

$$R = \frac{{r}_{1} * {w}_{1} + {r}_{2} * {w}_{2} + … + {r}_{x} * {w}_{x}}{{w}_{1} + {w}_{2} + … + {w}_{x}}$$

The weighting factor may be received as part of the search request and/or stored in a weighting factor database 38 stored in the non-transitory computer readable medium 32 of the vendor procurement apparatus 14. For example, a default weighting factor may be stored in the weighting factor database 38. This default weighting factor may be used unless or until a weighting factor is received from a vendor.

The weighting factor may include a set of individual weighting factors. The individual weighting factors may each be applied to a particular metric. The weighting factor applied to determine a task rating may also be dependent upon the type (e.g., practice area) of the new task. For example, a carrier may create a weighting rule specific to worker's compensation cases in Nevada. The weighting rule may specify the following weights: Cycle Time 5/10, Legal Spend 4/10, Budget Accuracy 2/10, Indemnity 7/10, Ratio Legal Spend/Indemnity 10/10. In this example, if the weighting factor does not include an individual weighting factor for a metric, the vendor procurement apparatus 14 may apply the individual weighting factor for this metric stored in the default weighting factor or a common weighting factor to be used for any metric for which a weighting factor is not specified.

The processor 30 determines a prediction of future performance of the new task by the identified vendor based on the determined task rating(s). In one example the prediction of future performance is equal to the determined task rating(s). Where multiple task ratings were determined for a given vendor, the prediction of future performance for the given vendor may be an average of the determined task ratings. As will be understood by one of ordinary skill in the art, the prediction of future performance is not limited to being equal to a task rating or the average of the determined task ratings for a given vendor. The prediction of future performance may, e.g., be equal to determined task rating(s) mapped to a single value based on predictive analysis. For example, if the vendor Bob has twenty-five task ratings in a range from four to eight, the processor 30 of the vendor procurement apparatus 14 may analyze the distribution of Bob's task ratings to determine the prediction of future performance. For example, the oldest task ratings may be given a lower weight than task ratings for more recent tasks. In another example, it may be known that task ratings from a first court are not good predictors of task performance in a second court. In this example, if the new task is for an assignment in the second court, the task ratings associated with tasks performed in the first court may be discarded or given a lower weight.

After the processor 30 determines the prediction of future performance of the new task, the network interface 36 provides to the carrier 12 information regarding the determined prediction of future performance of the identified vendor(s). The identified vendor need not be limited to a single vendor. Rather, multiple vendors may be identified. When multiple vendors have been identified, the information regarding the determined prediction of future performance of the identified vendors may be a rank ordered list, in which the order of the identified vendors is based on the prediction of future performance associated with each vendor of the identified vendors. As will be understood by one of ordinary skill in the art, the prediction of future performance is not limited to a rank ordered list, but rather may take any form capable of conveying a prediction of how the identified vendor(s) will perform the new task. For example, the prediction of future performance may include a table of values in which each identified vendor is associated with a number indicating a prediction of future performance by the vendor.

In one embodiment, the vendor procurement apparatus 14 functions as a legal professional service procurement apparatus for predicting future performance of a provider of professional services to insurance carriers. In this embodiment, the vendor database 18 may also be referred to as a professional service provider database, in which providers correspond to vendors in the vendor database 18. The professional service provider database stores a list of provider entries regarding a group of providers of professional services to insurance carriers and at least one property for each provider of the group of providers. The network interface 36 receives from an insurance carrier a search request pertaining to the new task and properties of a desired provider. The processor 30 identifies at least one provider in the professional service provider database. Each identified provider has at least one property that matches at least one property of the desired provider. For each identified provider, the processor 30 identifies at least one matching previous task performed by the identified provider that matches at least one characteristic of the new task. The processor 30 also (1) determines other matching tasks in the professional service provider database that match at least one characteristic of the matching previous task performed by the identified vendor and (2) determines statistical properties of the metrics associated with the other matching tasks. For each identified at least one matching previous task performed by the identified vendor and each metric associated with the identified matching previous task, the processor 30 converts the metric into a metric rating based on the determined statistical properties of that metric for the other matching tasks. The processor 30 also (1) determines a task rating for the identified matching previous task based on the at least one metric rating and a weighting factor and (2) determines a prediction of future performance of the new task by the identified provider based on the determined at least one task rating.

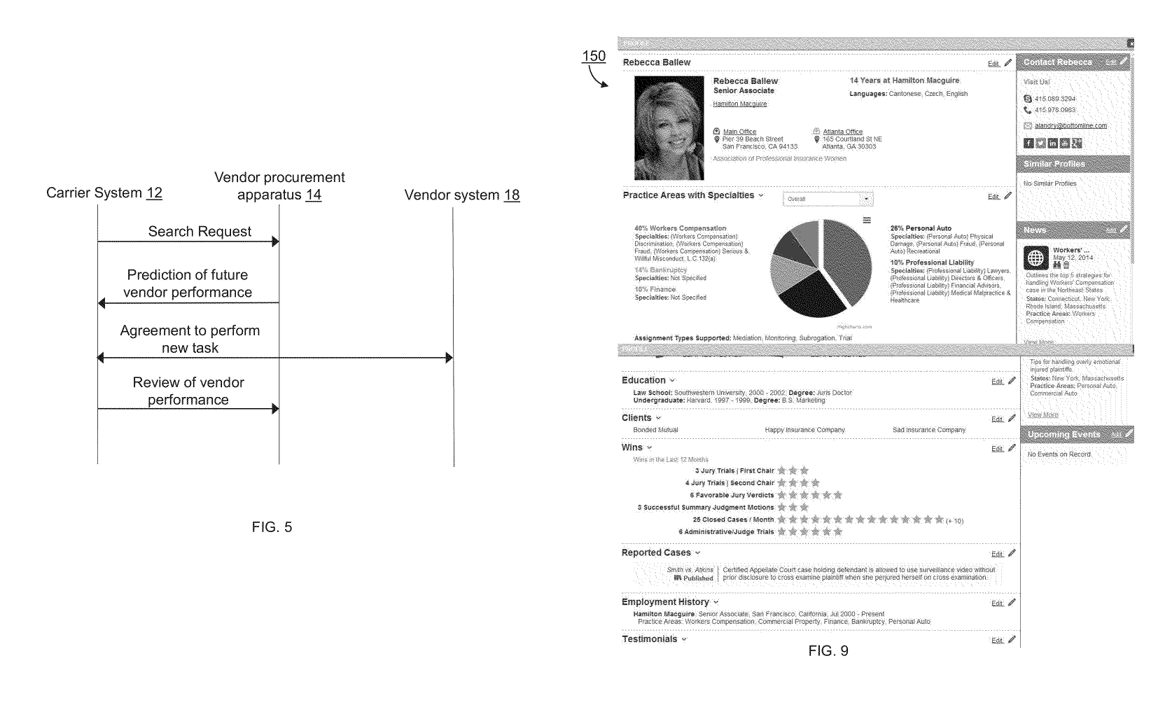

Turning to FIG. 5, a ladder diagram depicts the movement of information between the carrier system 12, vendor procurement apparatus 14, and vendor system 18. The carrier system 12 transmits a search request regarding a new task to the vendor procurement apparatus 14. As discussed above regarding FIG. 3, the search request 80 may include new task characteristics 82, desired vendor properties 84, and/or a weighting factor 86. The vendor procurement apparatus 14 analyzes the vendor database 34 to determine previous tasks performed by vendors matching the desired vendor properties 84.

After determining a prediction of future vendor performance for vendors identified as matching the desired vendor characteristic(s), the vendor procurement apparatus 14 transfers the prediction of future vendor performance to the carrier system 12. The carrier system 12 receives the prediction of future vendor performance and makes a selection regarding which vendor to enlist to perform the new task. The carrier system 12 may select a particular vendor by displaying the prediction of future vendor performance and allowing a user to choose a particular vendor based on the predictions presented. Alternatively, the carrier system 12 may automatically choose the vendor system 18 predicted to have the best future performance. Upon selecting a particular vendor to enlist, the carrier system 12 and vendor system 18 communicate to establish an agreement to perform the new task. The communication between the carrier system 12 and the vendor system 18 may occur with or without involvement of the vendor procurement apparatus 14.

Following completion of the new assignment by the vendor system 18, the carrier system 12 may provide a review of the vendor 18 to the vendor procurement apparatus 14. The review may include a ranking of the vendor's performance in general on a scale (e.g., from one to five stars). The review may also include separate rankings for different aspects of the vendor (e.g., communication, strategy, etc.). This review may then be used by the vendor procurement apparatus 14 to determine a task rating for the new task. This task rating of the new task may then be used by the vendor procurement apparatus 14 in the future when predicting a future performance of the vendor for new tasks.

As will be understood by one of ordinary skill in the art, information may be transmitted between the carrier system 12, vendor procurement apparatus 14, and vendor system 16 using any suitable protocol (e.g., TCP/IP, Bluetooth, SMTP, HTTP, SSL, PPP, or IMAP).

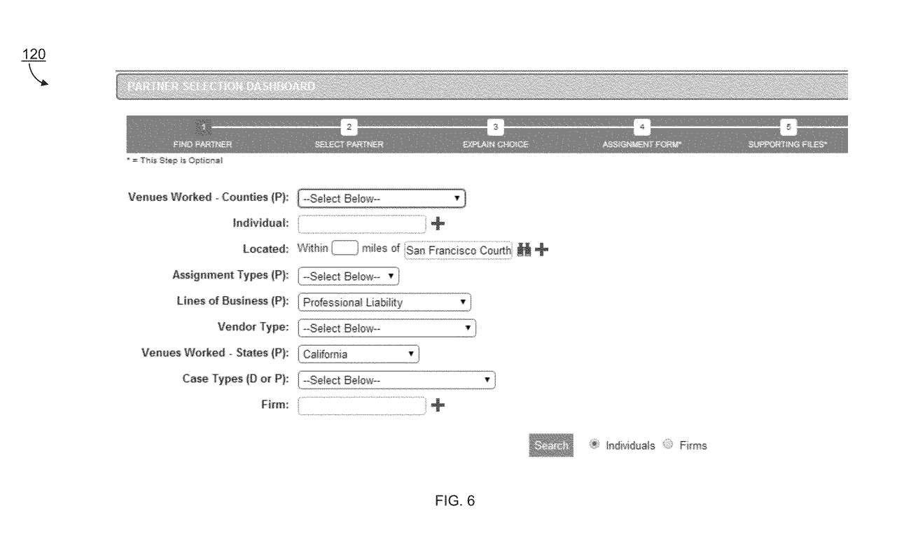

Turning to FIG. 6, an exemplary user interface 120 for a carrier 12 to enter desired vendor properties 84 is shown. The user interface 120 includes fields for inputting a list of venues worked (counties and states), a location within a given distance from a particular location (e.g., San Francisco), assignment types, lines of business, vendor type, case types, and whether individuals or firms are searched.

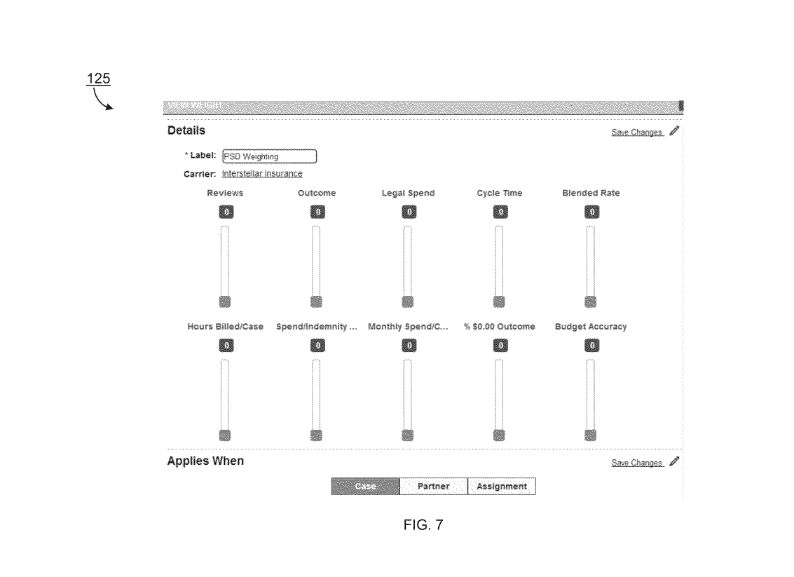

With reference to FIG. 7, a user interface 125 for inputting a weighting factor is shown. The user interface 125 includes slider bars for weighting the different metrics. The metrics include reviews, outcome, legal spend, cycle time, blended rate, hours bill/case, spend/indemnity ratio, monthly spend/case, outcome in dollars, and budget accuracy. By adjusting the position of the slider, a carrier 12 is able to adjust the weighting factor.

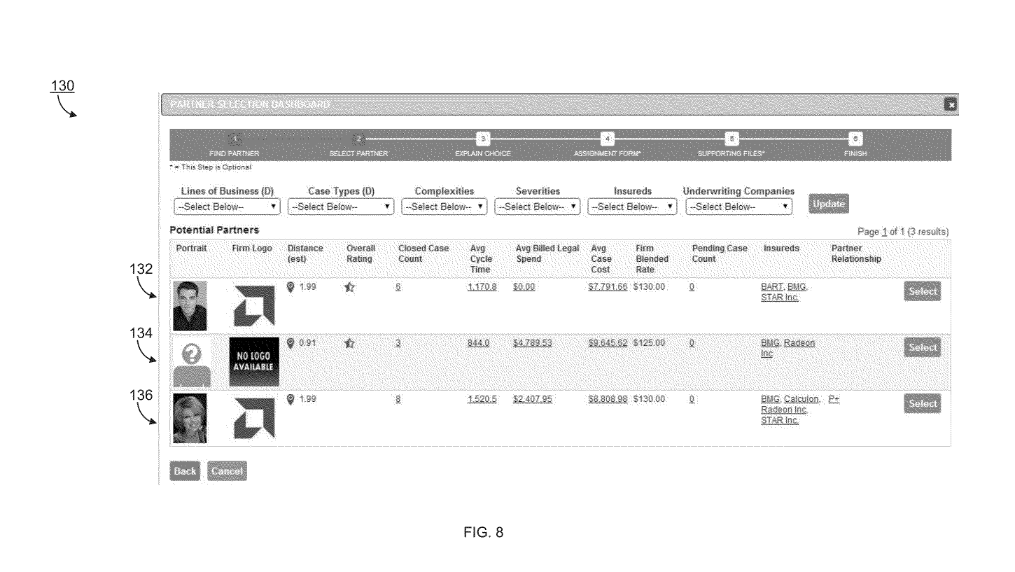

Turning to FIG. 8, after the vendor 12 enters the desired vendor properties, the vendor 12 is presented a user interface 130 showing the identified vendors. The user interface 130 in FIG. 8 does not include a graphical or numeric representation of the prediction of future performance of the new task by the identified vendors, but rather the identified vendors are displayed in an order determined based on the prediction of future performance. That is, in FIG. 8, the first listed vendor 132 was determined to have a better prediction of future performance than second listed vendor 134 and the third listed vendor 136. In another example, the prediction of future performance for each vendor may be displayed along with the vendor properties shown in the user interface 130. For example, the prediction of future performance may be shown as a rating on a specified scale (e.g., from one to five stars).

Turning to FIG. 9, a vendor profile 150 is shown. The vendor profile 150 may be shown if a carrier 12 selects a vendor 16 from the list shown in FIG. 8. The vendor profile 150 allows the carrier 12 to view additional information regarding the vendor 16.

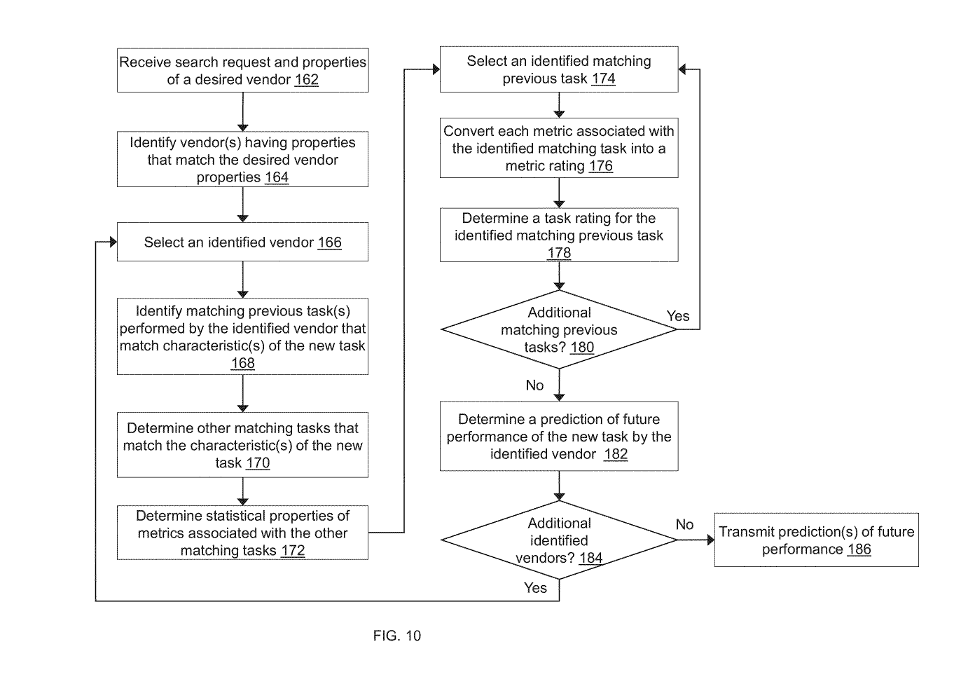

Turning to FIG. 10, a method for predicting future vendor performance based on previous vendor performance is shown. As described above, the steps of the method may be performed by the processor 30 of the vendor procurement apparatus 14. In processing block 162, a search request pertaining to the new task and properties of a desired vendor are received. In process block 164, vendor(s) are identified in the vendor database that have properties that match properties of the desired vendor. In process block 166, an identified vendor is selected. In process block 168, previous task(s) performed by the identified vendor are identified that match characteristic(s) of the new task. In process block 170, other matching tasks stored in the vendor database are identified that match characteristic(s) of the matching previous task performed by the identified vendor. In process block 172, statistical properties of metrics associated with the other matching tasks are determined.

In processing block 174, an identified matching previous task performed by the identified vendor is selected. In process block 176, each metric associated with the selected identified matching previous task is converted into a metric rating based on the determined statistical properties of that metric for the other matching tasks. In process block 178, a task rating is determined for the selected identified matching previous task based on the at least one metric rating and a weighting factor. In decision block 180, a check is performed to determine if there are additional matching previous tasks performed by the identified vendor. If there are additional matching previous tasks, processing returns to process block 174. If there are no additional matching previous tasks, processing continues to process block 182. In process block 182, a prediction of future performance of the new task by the identified vendor is determined based on the determined at least one task rating.

In decision block 184, a check is performed to determine if there are additional identified vendors for which a prediction of future performance has not yet been determined. If there are additional identified vendors to determine a prediction of future performance for, then processing returns to processing block 166 and a new identified vendor is selected. If there are no additional identified vendors to determine a prediction of future performance for, then processing moves to processing block 186. In processing block 186, the prediction(s) of future performance are transmitted to the carrier 12.

As will be understood by one of ordinary skill in the art, the processors 30 of the vendor procurement apparatus 14 may have various implementations including any suitable device, such as a programmable circuit, integrated circuit, memory and I/O circuits, an application specific integrated circuit, microcontroller, complex programmable logic device, other programmable circuits, or the like. The processor 30 may also include a non-transitory computer readable medium, such as random access memory (RAM), a read-only memory (ROM), an erasable programmable read-only memory (EPROM or Flash memory), or any other suitable medium. Instructions for performing the methods described above may be stored in the non-transitory computer readable medium and executed by the processor 30. The processor 30 may be communicatively coupled to the computer readable medium 32 and network interface 36 through a system bus, mother board, or using any other suitable structure known in the art.

The network interface 36 of the vendor procurement apparatus 14 may be communicatively coupled to one or more carrier systems 12 and vendor systems 16 via a network 18. The network 18 may be an open network, such as the Internet, a private network, such as a virtual private network, or any other suitable network. The prediction of future performance transmitted by the network interface 36 may comprise one or more electronic files including.

As will be understood by one of ordinary skill in the art, the network interface 36 may comprise a wireless network adaptor, an Ethernet network card, or any suitable device for performing network based communication between devices. The network interface 36 may be communicatively coupled to the computer readable medium 32 such that each network interface 36 is able to send data stored on the computer readable medium 32 across the network 15 and store received data on the computer readable medium 32. The network interface 36 may also be communicatively coupled to the processor 30 such that the processor 30 is able to control operation of the network interface 36. The network interface 36, computer readable medium 32, and processor 30 may be communicatively coupled through a system bus, mother board, or using any other suitable manner as will be understood by one of ordinary skill in the art.

Although the invention has been shown and described with respect to certain exemplary embodiments, it is obvious that equivalents and modifications will occur to others skilled in the art upon the reading and understanding of the specification. It is envisioned that after reading and understanding the present invention those skilled in the art may envision other processing states, events, and processing steps to further the objectives of system of the present invention. The present invention includes all such equivalents and modifications, and is limited only by the scope of the following claims.

What is claimed is:

1. A vendor procurement apparatus for predicting future vendor performance for a new task based on previous vendor performance, the vendor procurement apparatus comprising:
a non-transitory computer readable medium storing:
a vendor database, wherein:
the vendor database stores a list of vendor entries regarding a group of vendors and at least one property for each vendor of the group of vendors;
each vendor entry identifies a particular vendor and objective data for at least one previous task performed by the particular vendor; and
the objective data includes metrics regarding the particular vendor's performance of the associated previous task;
a network interface configured to receive from a carrier a search request pertaining to the new task and properties of a desired vendor; and
a processor configured to:
identify at least one vendor in the vendor database, wherein each identified vendor has at least one property that matches at least one property of the desired vendor; and
for each identified vendor:
identify at least one matching previous task performed by the identified vendor that matches at least one characteristic of the new task;
determine other matching tasks in the vendor database that match at least one characteristic of the matching previous task performed by the identified vendor;
determine statistical properties of the metrics associated with the other matching tasks;
for each identified at least one matching previous task performed by the identified vendor:
for each metric associated with the identified matching previous task, convert the metric into a metric rating based on the determined statistical properties of that metric for the other matching tasks; and
determine a task rating for the identified matching previous task based on the at least one metric rating and a weighting factor, wherein the weighting factor applies a weight to each metric rating; and
determine a prediction of future performance of the new task by the identified vendor based on the determined at least one task rating.

2. The vendor procurement apparatus of claim 1, wherein the prediction of future performance for a given vendor is an average of the determined at least one task rating.

3. The vendor procurement apparatus of claim 1, wherein:
the determined statistical properties of the metrics associated with the other matching tasks include the mean value and the standard deviation of the metrics;
the metric rating for a given metric associated with the identified matching task is equal to a constant value plus or minus a number of half standard deviations by which the given metric differs from the mean value of that metric associated with the other matching tasks.

4. The vendor procurement apparatus of claim 3, wherein:
the metric rating is determined for each metric associated with the identified matching previous task; and
the task rating is equal to the sum of each metric rating multiplied by the weight associated with the metric divided by the sum of the weights associated with each metric rating.

5. The vendor procurement apparatus of claim 3, wherein the constant value equals 5.

6. The vendor procurement apparatus of claim 1, wherein the weighting factor is received as part of the search request and/or is stored in a weighting factor database stored in the non-transitory computer readable medium.

7. The vendor procurement apparatus of claim 1, wherein the carrier specifies the criteria for determining whether a particular property of a particular vendor matches a particular property of the desired vendor and/or whether a particular previous task stored in the vendor database matches the at least one characteristic of the new task.

8. The vendor procurement apparatus of claim 1, wherein the criteria for determining whether a particular property of a particular vendor matches a particular property of the desired vendor and/or whether a particular previous task stored in the vendor database matches the at least one characteristic of the new task is stored in a criteria matching database stored in the non-transitory computer readable medium.

9. The vendor procurement apparatus of claim 1, wherein the other matching tasks do not include previous tasks performed by the identified vendor.

10. The vendor procurement apparatus of claim 1, wherein the new task is requested by an insurance carrier and the vendors provide professional services.

11. The vendor procurement apparatus of claim 1, wherein:
the processor is further configured to analyze the new task to determine the at least one characteristic of the new task; or
the network interface is further configured to receive at least one characteristic of the new task.

12. The vendor procurement apparatus of claim 1, wherein the network interface is further configured to provide to the carrier information regarding the determined prediction of future performance of the identified at least one vendor.

13. The vendor procurement apparatus of claim 1, wherein:
the identified at least one vendor includes multiple vendors; and
the information regarding the determined prediction of future performance of the identified vendors is rank ordered based on the prediction of future performance associated with each vendor of the identified vendors.

14. A method for predicting future vendor performance for a new task based on previous vendor performance, the method comprising:
receiving from a carrier a search request pertaining to the new task and properties of a desired vendor;
identifying at least one vendor in a vendor database stored on a non-transitory computer readable medium, wherein each identified vendor has at least one property that matches at least one property of the desired vendor;
for each identified vendor:
identifying at least one matching previous task performed by the identified vendor that matches at least one characteristic of the new task;
determining other matching tasks stored in the vendor database that match at least one characteristic of the matching previous task performed by the identified vendor;
determining statistical properties of metrics associated with the other matching tasks;
for each identified at least one matching previous task performed by the identified vendor:
for each metric associated with the identified matching previous task, converting the metric into a metric rating based on the determined statistical properties of that metric for the other matching tasks;
determining a task rating for the identified matching previous task based on the at least one metric rating and a weighting factor, wherein the weighting factor applies a weight to each metric rating;
determining a prediction of future performance of the new task by the identified vendor based on the determined at least one task rating.

15. The method of claim 14, wherein the prediction of future performance for a given vendor is an average of the determined at least one task rating.

16. The method of claim 14, wherein:
the determined statistical properties of the metrics associated with the other matching tasks include the mean value and the standard deviation of the metrics; and
the metric rating for a given metric associated with the identified matching task is equal to a constant value plus or minus a number of half standard deviations by which the given metric differs from the mean value of that metric associated with the other matching tasks.

17. The method of claim 16, wherein:
the metric rating is determined for each metric associated with the identified matching previous task;
the task rating is equal to the sum of each metric rating multiplied by the weight associated with the metric divided by the sum of the weights associated with each metric rating.

18. A legal professional service procurement apparatus for predicting future performance of a provider of professional services to insurance carriers for a new task based on previous performance, the procurement apparatus comprising:
a non-transitory computer readable medium storing:
a professional service provider database, wherein:
the professional service provider database stores a list of provider entries regarding a group of providers of professional services to insurance carriers and at least one property for each provider of the group of providers;
each provider entry identifies a particular provider and objective data for at least one previous task performed by the particular provider; and
the objective data includes metrics regarding the particular provider's performance of the associated previous task;
a network interface configured to receive from an insurance carrier a search request pertaining to the new task and properties of a desired provider; and
a processor configured to:
identify at least one provider in the professional service provider database, wherein each identified provider has at least one property that matches at least one property of the desired provider; and
for each identified provider:
identify at least one matching previous task performed by the identified provider that matches at least one characteristic of the new task;
determine other matching tasks in the professional service provider database that match at least one characteristic of the matching previous task performed by the identified vendor;
determine statistical properties of the metrics associated with the other matching tasks;
for each identified at least one matching previous task performed by the identified vendor:
for each metric associated with the identified matching previous task, convert the metric into a metric rating based on the determined statistical properties of that metric for the other matching tasks; and
determine a task rating for the identified matching previous task based on the at least one metric rating and a weighting factor, wherein the weighting factor applies a weight to each metric rating; and
determine a prediction of future performance of the new task by the identified provider based on the determined at least one task rating.

19. The legal professional service procurement apparatus of claim 18, wherein the prediction of future performance for a given provider is an average of the determined at least one task rating.

20. The legal professional service procurement apparatus of claim 18, wherein:
the determined statistical properties of the metrics associated with the other matching tasks include the mean value and the standard deviation of the metrics;
the metric rating for a given metric associated with the identified matching task is equal to a constant value plus or minus a number of half standard deviations by which the given metric differs from the mean value of that metric associated with the other matching tasks.

21. The legal professional service procurement apparatus of claim 20, wherein:
the metric rating is determined for each metric associated with the identified matching previous task; and
the task rating is equal to the sum of each metric rating multiplied by the weight associated with the metric divided by the sum of the weights associated with each metric rating.
